(19) United States
(12) Patent Application Publication
(10) Pub. No.: US 2019/0125105 A1
(43) Pub. Date: May 2, 2019

(54) STORE DISPLAY FOR MOBILE COMPUTING DEVICES

(71) Applicant: Walmart Apollo, LLC, Bentonville, AR (US)

(72) Inventors: Yurgis Mauro Bacallao, Centerton, AR (US); Douglas Jahe Ryner, Cave Springs, AR (US); Donald Wayne White, III, Kansas, OK (US)

(21) Appl. No.: 16/161,234

(22) Filed: Oct. 16, 2018

Related U.S. Application Data
(60) Provisional application No. 62/579,334, filed on Oct. 31, 2017.

(51) Int. Cl. A47F 9/04; A47F 7/00; A47F 5/10; H02J 7/00; G06F 1/16

(52) U.S. Cl. CPC A47F 9/042; A47F 7/00; A47F 2009/041; H02J 7/0027; G06F 1/1632; A47F 5/10

(57) ABSTRACT

A multi-purpose store display comprises a central section including a set of mobile computer charging cradles, each constructed and arranged to receive, position, and electrically charge a mobile computing device; a bag holder assembly at one or more sides of the central section that is constructed and arranged to hang a plurality of shopping bag; and an electrical system for providing a source of power to the mobile computer charging cradles.

### CROSS REFERENCE TO RELATED APPLICATIONS

This application claims the priority and benefit of U.S. Application No. 62/579,334 entitled “Store Display for Mobile Computing Devices” filed Oct. 31, 2017, the contents of which are hereby incorporated by reference.

### FIELD OF THE DISCLOSURE

The present disclosure relates generally to shopper-friendly store displays, and more specifically to a store display that co-locates mobile computing devices, shopping bags, and/or other items for use by a store customer.

### BACKGROUND

Contemporary retail stores continue to implement computer technology in an effort to attract new customers and to maintain the store loyalty of present customers. For example, a point-of-sale (POS) system may be modified to automate checkout procedures. In doing so, the checkout time can be reduced, which may simplify and enhance a store customer's shopping experience.

### SUMMARY

In one aspect, a multi-purpose display comprises a central section including a set of mobile computer charging cradles, each constructed and arranged to receive, position, and electrically charge a mobile computing device; a bag holder assembly at one or more sides of the central section that is constructed and arranged to hang a plurality of shopping bag; and an electrical system for providing a source of power to the mobile computer charging cradles.

In some embodiments, the bag holder assembly includes a bagging hook arrangement for hanging the shopping bags.

In some embodiments, the bag holder assembly includes a wire frame that at least partially surrounds the bagging hook arrangement.

In some embodiments, the central region includes a signage area.

In some embodiments, the central section is modular, and includes a first portion and a second portion that abuts the first portion in a closed state and is separate from the first portion in an open state, wherein an interior region between the first portion and the second portion is exposed in the open state.

In some embodiments, the multi-purpose store display further comprises an electronic kiosk coupled to the electrical system.

In another aspect, a multi-purpose store display comprises a base including a first side, a second side, and a third side collectively constructed and arranged as a triangular configuration, wherein at least one of the first through third sides includes a set of mobile computer charging cradles constructed and arranged to receive, position, and electrically charge the array of mobile computing devices, wherein at least one other of the first through third sides includes at least one of a bag holder assembly or a set of shelves, and wherein the base further includes an electronic kiosk that is collocated with the mobile computer charging cradles and the at least one of the bag holder assembly or set of shelves.

In some embodiments, the multi-purpose store display further comprises an electrical system for providing a source of power to the mobile computer charging cradles.

In some embodiments, the multi-purpose store display further comprises an electronic kiosk coupled to the electrical system and that communicates with the mobile computing devices in the mobile computer charging cradles.

In some embodiments, the first side and the second side each comprises an array of the mobile computer charging cradles, and the third side includes the electronic kiosk.

In some embodiments, the base further comprises one or more display panels.

In some embodiments, the base is modular, and wherein at least one of the first through third sides abuts another of the first through third sides in a closed state and is separate from the other of the first through third sides in an open state, wherein an interior region formed by the first through third sides is expanded and exposed in the open state.

In some embodiments, the multi-purpose store display further comprises corner regions between the first through third sides for additional elements of the bag holder assembly or additional mobile computer charging cradles.

In another aspect, a modular store display comprises a first portion; a second portion that abuts the first portion in a closed state and is separate from the first portion in an open state; a first set of mobile computer charging cradles at the first portion; a first set of shelves at the second portion; and at least one of a second set of mobile computer charging cradles, a second set of shelves, or a bag holder assembly at an interior region between the first portion and the second portion in the open state.

In some embodiments, the first portion includes first and second sides and the second portion includes a third side that separates from the first portion in the open state and that abuts the first portion in the closed state.

In some embodiments, the third side includes a set of shelves.

In some embodiments, in the open state, the interior region is expanded and exposed to accommodate additional mobile computer charging cradles.

In some embodiments, the first portion further includes a bag holder assembly.

### BRIEF DESCRIPTION OF THE DRAWINGS

Exemplary embodiments will now be described, by way of example only, with reference to the following drawings, in which:

FIG. 1 is a perspective view of a store display, in accordance with some embodiments.

FIG. 2 is a front perspective view of the store display of FIG. 1 including a set of kiosk display panels, in accordance with some embodiments.

FIG. 3 is a rear perspective view of the store display of FIGS. 1 and 2.

FIG. 4 is a block diagram of an electrical system of a store display, in accordance with some embodiments.

FIGS. 5A, 5B and 5C are perspective views of a store display, in accordance with other embodiments.

FIG. 6 is a perspective view of the store display of FIGS. 5A-5C having a different configuration, in accordance with other embodiments.

FIGS. 7A, 7B and 7C are perspective, front, and top views, respectively, of a store display in an open state, in accordance with other embodiments.

### DESCRIPTION OF PREFERRED EMBODIMENTS

Modern retail establishments, such as supermarkets, department stores, shopping malls and plazas, and so on, have implemented computerized systems to allow store associates to operate a handheld computer device to read the barcode markings on selected items of interest, for example, when placing the items into the shopping cart or basket. Some stores empower its customers to perform such tasks, for example, by availing the customers with a Motorola MC18 mobile computing device or other handheld computing device to perform functions otherwise performed by a store associate, such as scanning universal product code (UPC) barcode labels, self-checkout, and so on.

Embodiments of the present inventive concepts include a store display that provides a combination of and co-locates an arrangement of store-provided handheld computing devices with an arrangement of shopping bags and/or store accessories so that a store customer can retrieve a shopping bag, a store-provided handheld computing device, and/or other items from a single location that may be useful to the store customer during a shopping event, such as hosted scanners, monitors, and/or other electronic devices used by a shopper.

The store display is preferably located at or near a store entrance so that customers can retrieve both a scanner and shopping bag prior to the start of a shopping event, which allows the customer to spend an optimal amount of time enjoying a shopping experience, and minimal time performing less desirable activities such as performing a checkout operation. Alternatively or in addition, the store display may be provided at or near a store exit or checkout counter, where a customer may retrieve a bag for inserting store items from a shopping cart, basket, or carried by the shopper, and also retrieve a scanner for performing a self-checkout function with respect to the items. The scanner may be used for user-based point of sale or purchase-related operations, and the bag may be used to collect and transport items scanned by the scanning device. In other embodiments, the store display is located at or near a checkout, such as a self checkout, a conventional checkout, or a customer service style checkout, where a customer can return the of store-provided handheld computing devices, by placing the handheld device into an available cradle slot.

Also, the store display is constructed and arranged to provide more customer autonomy, and less store associate involvement, by providing the necessary accessories to a customer entering the store, i.e., scanning device, shopping bag(s), and/or other store accessories, which reduces the need for store associates to provide functions on behalf of the customer, such as point of sale checkout and bagging. Therefore, since the customer performs the self-checkout and self-bagging functions historically performed by a store associate, the powered store display provides a more effective method for allowing customers to self-scan merchandise items and to complete purchase transactions, while also providing the opportunity for the customers to bag their items.

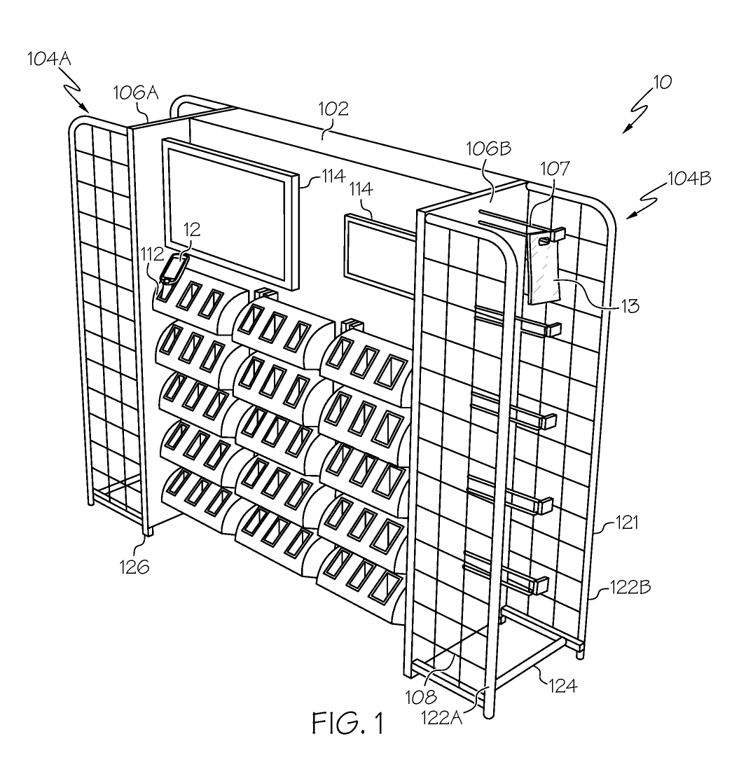

FIG. 1 is a perspective view of a store display 10, in accordance with some embodiments.

The store display 10 is constructed and arranged to co-locate shopping bags and/or store accessories with an arrangement of store-provided handheld computing devices such as Motorola MC18 mobile computing devices or the like, so that a store customer can retrieve a shopping bag, a store-provided handheld computing device, and/or other items that may be useful to the store customer during a shopping event.

In some embodiments, the store display 10 comprises a center body portion 102, a first bag holder assembly 104A at one side of the center body portion 102, a second bag holder assembly 104B at another side of the center body portion 102, and a plurality of mobile computer charging cradles 112.

The center body portion 102 preferably has a square or rectangular configuration, and is constructed and arranged to receive and couple to the mobile computer charging cradles 112. In some embodiments, the charging cradles 112 include couplings such as screws, adhesives, and so on for attaching to a wall of the center body portion 102. In other embodiments, the center body portion 102 includes shelves, hooks, or other elements such as couplings 109 protruding from the wall of the center body portion 102 to which the charging cradles are coupled.

The charging cradles 112 are arranged as a modular docking cradle system, for example, an array of multi-slot cradles including five rows of 3-socket unibody docking cradles as shown in FIG. 1 to provide sufficient cradle density of 27 handheld computing devices, or more, especially where lack of space may be an issue in the store. The cradles 112 may extend in a perpendicular direction from the vertical wall of the center body portion 102, or may may extend at an angle other than orthogonal from the vertical wall for ease of access of the mobile computing devices 12 positioned in the cradles 112.

The modular system permits a charging cradle 112 in the array to be replaced with another cradle, or otherwise left alone without affecting the other cradles 112 in the array, so it is not necessary to replace the entire array or electrical system. Rather, due to the modularity of the cradles 112 and the components thereof, if one cradle 112 fails, then only that cradle 112 need be replaced while the others remain intact and functional.

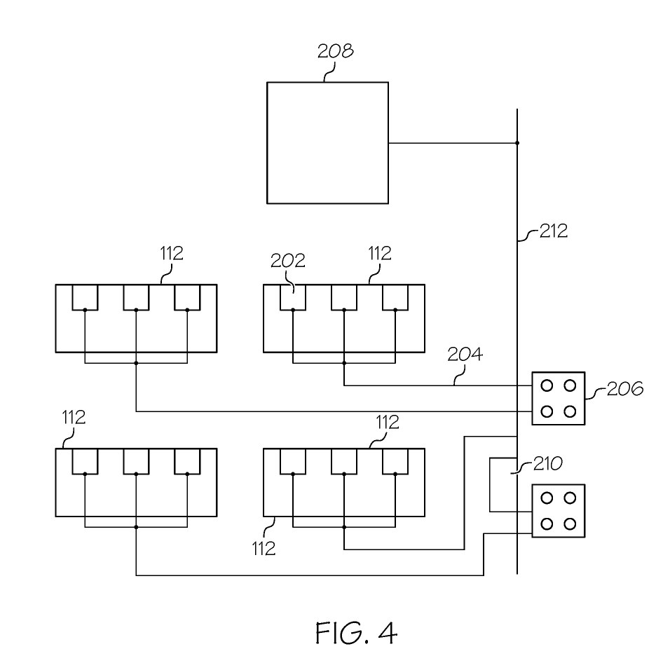

Each docking cradle 112 can receive a Motorola MC18 mobile computing device or related barcode scanner, or any electronic device relying on a rechargeable battery such as, for example, a smartphone or the like. In other embodiments, the charging cradles may be single socket cradles, each coupled to a rack or other coupling element of the center body portion 102. As shown in FIG. 4, each slot or socket in the charging cradles 112 may include an electrical connector that directly abuts a conductive power connector 14 of a mobile handheld computing device 12 positioned in the cradle 112. Each charging cradle 112 may include coupling elements such as tie down holes, screws, bolts, clamps, and so on for directly coupling to a sidewall of the center body portion 102. Each charging cradle 112 can have a conductive coupling that allows a battery, memory, and/or other electrical components to be powered via the coupling that receives a source of power from a power source. A charging cradle 112 may have a data port or the like so that the mobile computing device 12 positioned in the cradle 112 may exchange data with another computer, for example, at a different location, via the data port.

Referring again to FIG. 1, a handheld computing device 12 located at the store display may be Motorola MC18 mobile computing device or the like. The handheld computing device 12 preferably includes a scanning element, such as barcode scanner, wireless communications interface, battery, charging port, computer processor, memory, and display screen. The wireless communications interface allows the store customer to transmit purchase information to a store network server or host computer. During operation, the mobile handheld computing device 12 may be used to verify the present price of an item, allowing the store customer to decide whether or not to purchase that item. Each customer's running total is maintained in a file and is available to a check-out clerk when the customer is ready to pay for the goods and leave the store. Each mobile computing device 12 may be provided with a charged battery before being issued to a customer. The customer may also have access to at least one shopping bag 13 co-located with the issued mobile computing device 12, allowing the customer a single source for receiving any store-related items necessary for the customer to shop, self-checkout, and otherwise perform tasks during the shopping experience that requires minimal or no involvement from store associates. The store display 10 also provides an alternative to a mobile scanning operation where the shopper uses a personal smartphone or the like that includes a scanning feature throughout the store to acquire items of interest.

The center body portion 102 is constructed and arranged to provide of view by people passing by the store display 10 of all mobile computer charging cradles 112, and the mobile computing devices 12 positioned in the charging cradles 112. This view provides shoppers allows customers entering the store easily access to the mobile computing devices 12, while providing offer a high number of handheld computing devices 12 in an optimized cradle density.

In addition to charging cradles 112, the center body portion 102 is constructed and arranged to receive and couple to one or more electronic displays 114, or banners, posters, or non-electronic display or signage. The displays 114 may be computer displays, television screens, or other electricity-powered display. In some embodiments, the displays 114 share a same power source as the charging cradles 112, for example, shown in FIG. 4. The center body portion 102 may include one or more holes for receiving power cords, data cables, electrical connectors, and so on that extend from the displays 114 via a charge pole 212 or the like to a power source, computer, and so on external to the store display 10.

The store display 10 may include a first side portion 106A extending perpendicularly from one side of the center body portion 102 and a second side portion 106B extending perpendicularly from the other side of the center body portion 102. An end region of each of the first and second side portions 106A, 106B (generally, 106) may, along with the center portion 102 form an enclosure that houses and displays the array of charging cradles 112.

Bag holder assembly 104A may be constructed and arranged as a wall mounted bag holder and therefore be coupled to first side portion 106A. Bag holder assembly 104B may also be constructed and arranged as a wall mounted bag holder and therefore be coupled to second side portion 106B. Each bag holder assembly 104A, 104B (generally, 104) may include a tubular frame 121 and a wire arrangement 108, for example, constructed and arranged as a wire cage inside the tubular frame 121. The wire arrangement 108 may allow viewers to see shopping bags at least partially surrounded by the wire arrangement 108. In addition, additional the wire arrangement 108 may be used to hang hooks, hangers, or the like, or displays or signage.

The frame 121 may be formed of tubular steel or the like. The frame 121 may include two portions 122A, 122B that extend from each side of a side portion 106. Each portion 122A, 122B (generally, 122) may have a vertical piece and a horizontal piece, which may be formed of a single tubular element, or formed of two separate pieces and connected by an elbow joint or the like. At least one crossbar 124 may extend between the two frame portions 122A, B, to provide further stability.

Each bag holder assembly 104 may include a plurality of feet, caster wheels, or the like at the bottommost region of the frame 121, on which the frame 121 is positioned. Caster wheels 126 may permit the store display 10 to be easily movable by a person applying a force to the display 10. In some embodiments, at least two wheels 126 are swivel wheels, for example, part of a swivel caster wheel assembly such as a polyurethane caster wheel assembly. The swivel wheels permit the display 10 to be positioned in small spaces or corners in the store. In some embodiments, at least one of the wheels 126 has an integrated directional swivel wheel lock or brake or the like to prevent rotation of these wheels to prevent the display 10 from moving during use.

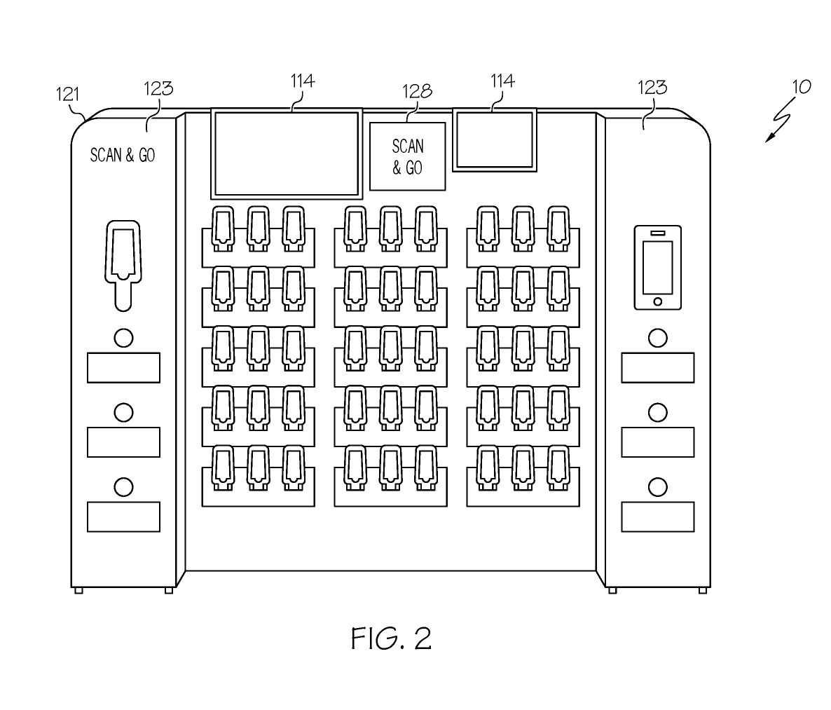

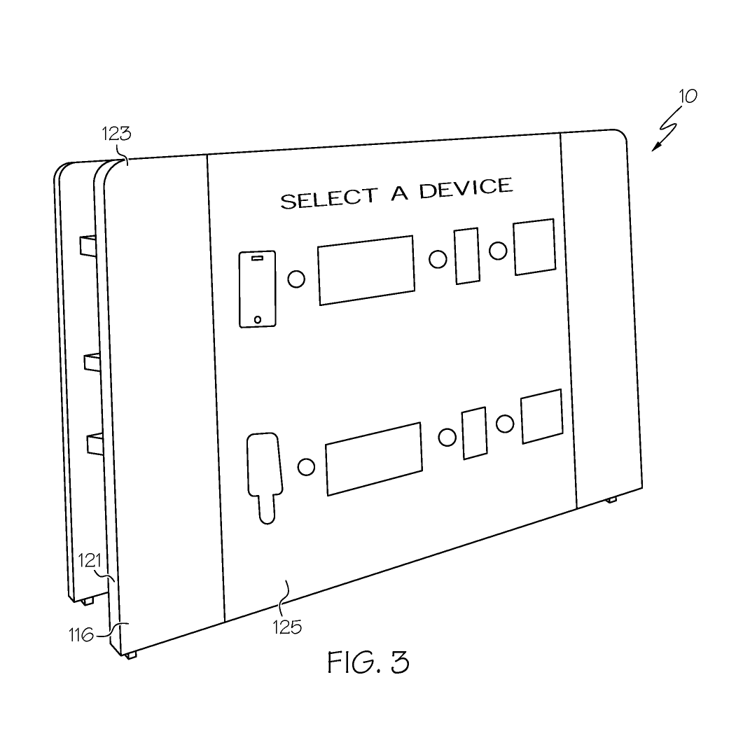

The wire arrangement 108 may include a plurality of vertical, horizontal, angled, and/or non-linear wire pieces coupled together to form a mesh, web, or grid-shaped arrangement. The wire arrangement 108 permits a viewer to see a bagging hook arrangement 107 extending from the side portions 106 between the frame portions 122A, 122B. The wire arrangement 108 may be constructed and arranged for forming a wire cage or the like at least partially about the bagging hook arrangements 107, and permitting panels, signs, non-electronic displays, or other signage, for example, kiosk panels 123, 125, 128 shown in FIGS. 2 and 3, to be attached to the bag holder assemblies 104A, 104B (generally, 104).

Each bag holder assembly 104 includes an arrangement of bagging hook arrangements 107 extending from the first and second side portions 106A. In some embodiments, the bag holder assemblies 104 are modular, and therefore include a back surface (not shown) that directly abuts and coupled to a side portion 106, and the bagging hook arrangements 107 extend from the modular back surface. In some embodiments, each bagging hook arrangement 107 includes a stackable set of bagging fixtures. The bagging hooks, rods, rings, or the like of the arrangement 107 may have a shape and configuration suitable for holding a shopping bag, and more specifically, receiving a handle, tabs, or the like of a plastic, paper, cloth, or other shopping bag, for example, hook, rod, ring, or other elements commonly used at a grocery or other store checkout, and that prevents a bag, e.g., a grocery bag, garment bag, or other shopping bag, from slipping off the bagging hook arrangement 107. The handle of a bag hanging from the bagging hook arrangement 107 may preferably by looped over hook, rod, ring, or the like to suspend one of the bags in an open position for receiving items, or a closed position for simply permitting a user to pull the shopping bag from the arrangement 107.

As shown in FIGS. 2 and 3, the store display 10 in some embodiments includes a set of kiosk display panels. The kiosk panels may include a display header 128, signs 125A, 125B (generally, 125), back display panels 116, and/or side display panels 123, but not limited thereto. Any or all of the display header 128, signs 125A, 125B (generally, 125), back display panels 116, and/or side display panels 123 may include advertising, graphics, text, and/or the like that may be appealing to a viewer. The kiosk panels may be positioned over at least portions of the bag holder assemblies 104. The signs 125 may cover some or all of a rear portion of the center body portion opposite the region exposing the charging cradles 112 for display.

FIG. 4 is a block diagram of an electrical system of the store display 10, in accordance with some embodiments. The electrical system is constructed and arranged to provide power, e.g., voltage and current, to the store display 10, including but not limited to the center body portion 102 and more specifically, the mobile computer charging cradles 112 and/or electronic displays 114 thereon, and/or the bag holder assemblies 104.

Each charging cradle 112 may be configured to charge or recharge at least one lithium-ion battery or the like of a handheld computing device 12, when positioned in a socket 202. The charging cradle 112 may include multiple sockets 202, each of which is configured to receive a handheld computing device 12, and each configured to provide electrical power via a charge pole 212 and the electrical connector 204 to the battery of the handheld computing device 12. Accordingly, any or all charging cradles 112 may receive a sufficient source of power to charge the batteries and/or other electrical components of the handheld computing devices 12 positioned in the charging cradles 112 and in electrical contact with the conductive elements in the cradle sockets 202. The electrical connectors 204 may extend from the charging cradles 112 to a multi-outlet unit 206 such as a quad electrical outlet that includes four outlets, each for receiving a plug or other conductive connector of the electrical connectors 204.

The electrical system may include a charge or electrical pole 212 and corresponding power unit 210. In some embodiments, the charge pole 212 is integral with the center body portion 102, and permits for a single electrical connection source for the cradles 204. In other embodiments, the electrical pole 212 is separate from but proximal to the center body portion 102, or other region of the display 10. Thus, the cradles 112 are each coupled to a power supply 208, which may be external from the store display 10 or part of the store display 10. Therefore, the cradles 112 receive power from the same power supply, or multiple or different power supplies. Also, the multiple partitions surrounding the pole 212 can be separated from the pole 212, removed from, and/or positioned about the pole depending on a desired configuration of the display 10

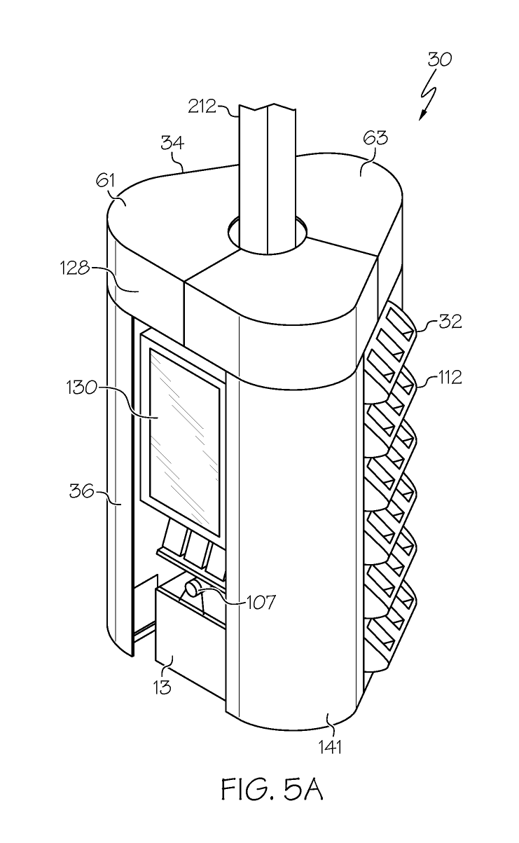

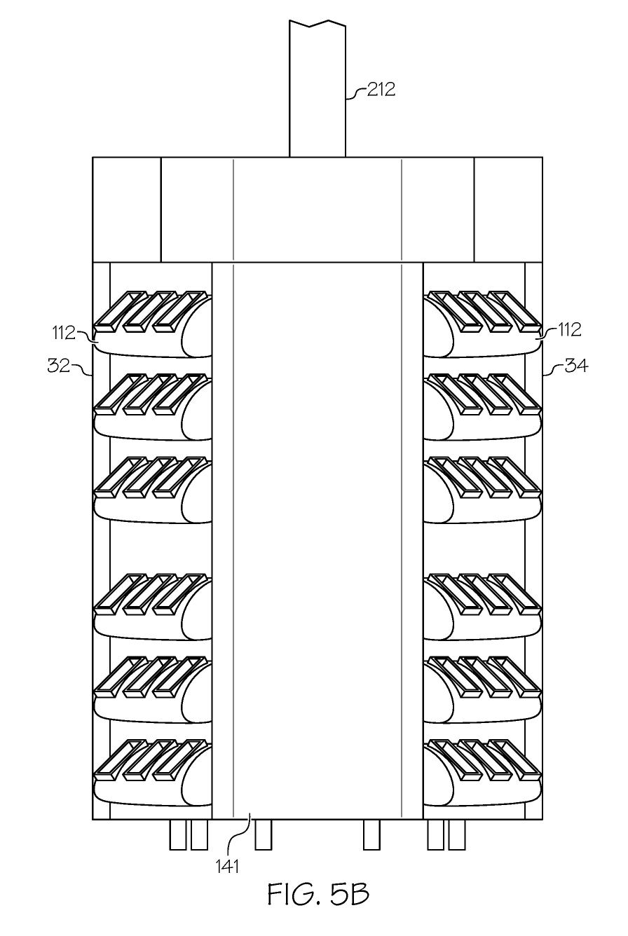

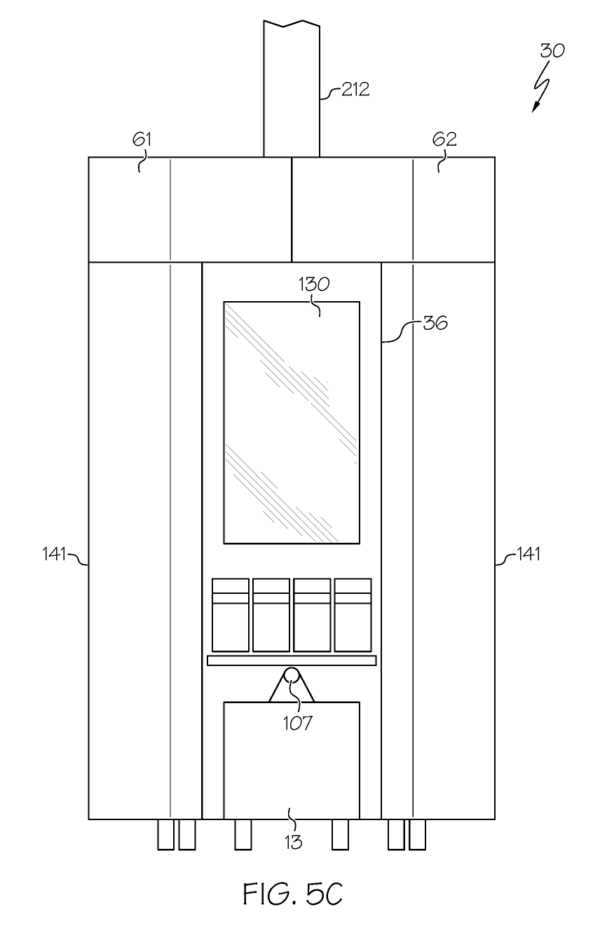

Referring to FIGS. 5A-5C, in some embodiments, a store display 30 includes a triangular configuration, where a base includes a first side 32 and second side 34 each includes an interior region for accommodating an array of charging cradles 112, and a third side 36 that includes an interior region for accommodating a kiosk display 130 and/or other accessories for assisting a shopper. The charging cradles 112 may be arranged in a similar manner as the arrangement described in FIGS. 1-3. However, the store display 30 may provide sufficient cradle density of 45 handheld computing devices, or more. At least one of the sides is constructed and arranged for an electronic kiosk or a non-electronic kiosk, for example, including a shelf, information board, and so on.

The store display 30 may include an electrical system similar to or the same as the electrical system described in FIG. 4. For example, an electrical pole 212 can extend through an interior of the store display 30, for example, extending vertically and surrounded by the three sides 32, 34, 36, each of which can be separated from the pole 212, or otherwise expanded to provide a region of separation from the pole 212. Details of the electrical system are not repeated for brevity. The store display 30 may also include display panels, similar to the kiosk display panels described with respect to FIGS. 2 and 3, such as a display header 128, signs, and so on.

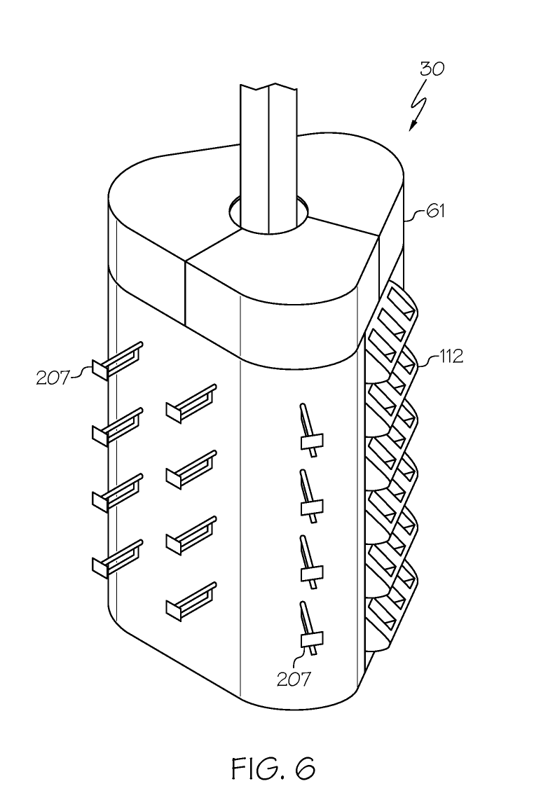

The store display 30 may include corner panels 141 between the various sides 32, 34, 36 of the store display 30. The corner panels 141 can be removed from the store display 30 so that one or more corners between the sides 32, 34, 36 can be used for other purposes, for example, as shown in FIG. 6, for presenting a bagging hook arrangement 207, which may be the same as or similar to the bagging arrangement 107 shown and described with respect to FIG. 1. Details of the bagging hook arrangement 207 of FIG. 6 are therefore not repeated for brevity. In some embodiments, at least one side 32, 34, 36 of the store display 30 may also, or alternatively, include a bagging hook arrangement the same as or similar to the bagging arrangement 107 shown and described with respect to FIG. 1. For example, one of the sides 32, 34 and all three corners 141 of the store display 30 shown in FIG. 6 may include a bagging arrangement, while another of the sides 32, 34 includes an array of charging cradles 112. Such arrangements and rearrangements may be performed by a user, for example, using a universal coupling (not shown) extending from the sides for coupling to either charging cradles 112 or the bagging arrangement 207.

The store display 30 may be modular, for example, where the sides 32, 34, 36 and corners 141 are removably coupled to each other. In addition, top portions 61, 62, 63 of the store display 30 may be removably coupled to the sides 32, 34, 36 and corners 141 of the store display 30, and replaced with additional bagging hook arrangement 107, charging cradles 112, shelves, and/or other accessories.

The kiosk display 130 positioned at the third side 36 of the store display 30 may include a computer screen, keyboard, and/or other accessories for permitting a user to perform shopping-related tasks from an electronic device. The computer screen and/or other electronic components of the kiosk display 130 may communicate via a wireless communication with the charging cradles 112 and/or the mobile computing device 12 positioned in the charging cradle 112, e.g., scanning device shown in FIG. 2, to exchange data between the kiosk display 130 and the mobile computing device 12 regarding a shopping-related function.

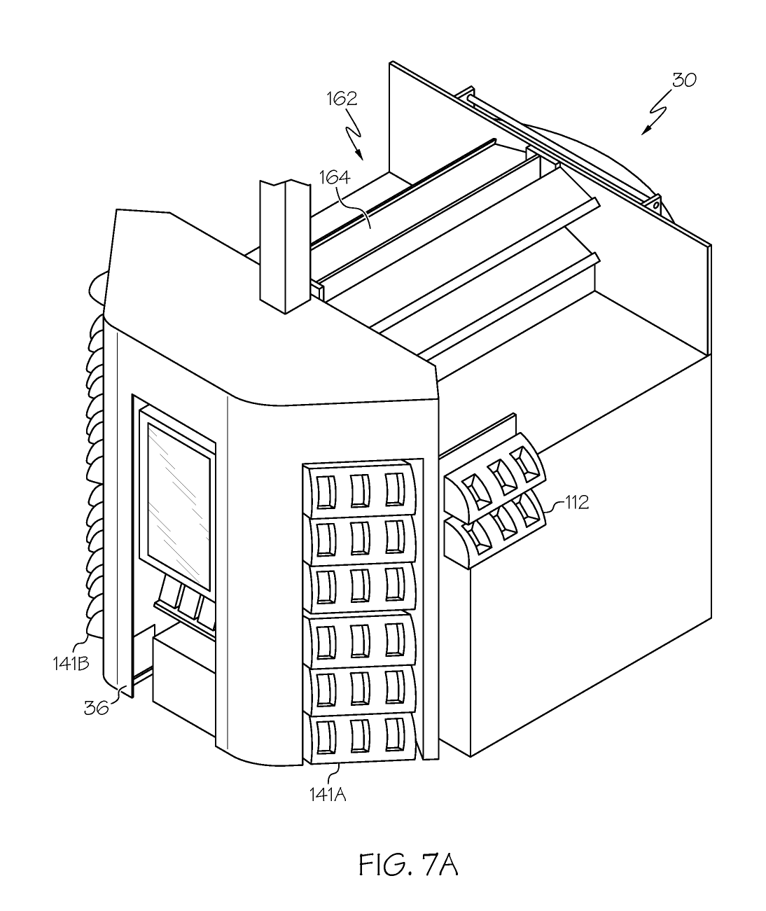

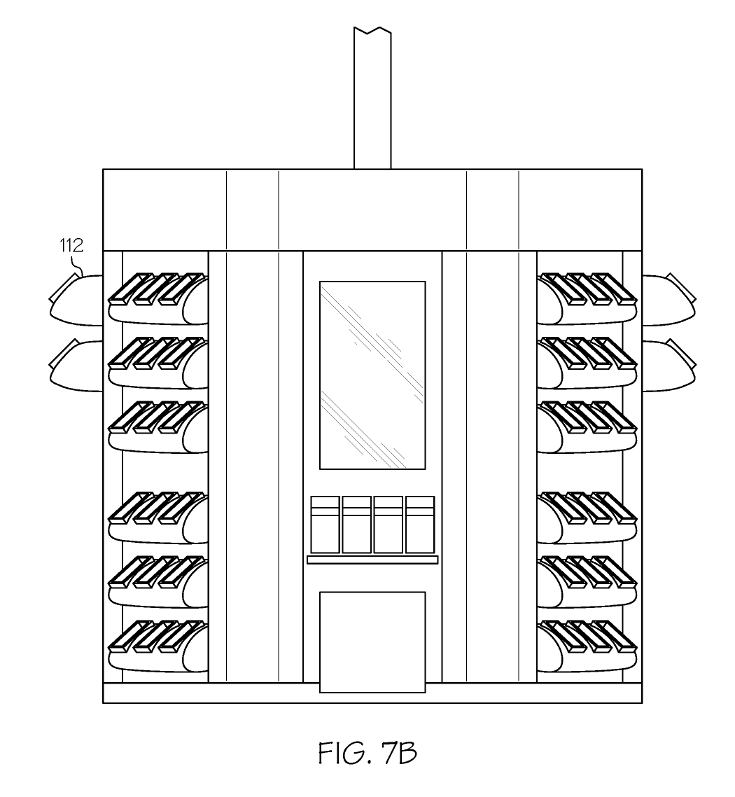

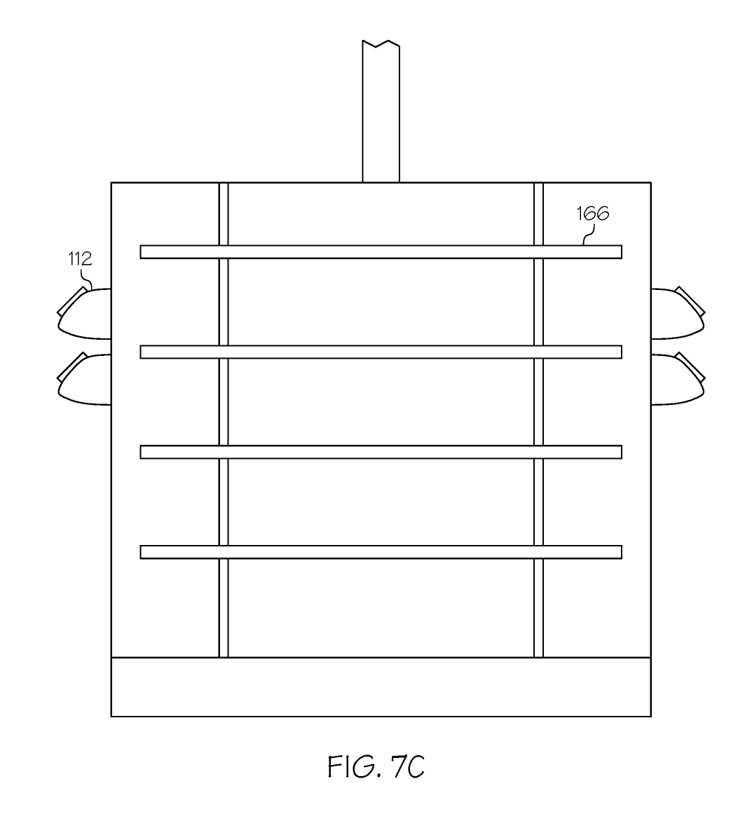

As shown in FIGS. 5A-6, when the store display 30 is in a closed position, a side 32, 34 of the store display 30 may display a single column of 3-socket charging cradles 112. As shown in FIGS. 7A-7C, a store display may be expanded to expose an interior 162 of the store display 30, and to permit additional columns of charging cradles 112. For example, the store display shown in FIG. 5A may be expanded as shown in FIG. 7A. The store display 30 may include a mechanical system comprising rails, wheels, and so on that permits one side 32, 34, 36 from the other two sides. For example, as shown in FIG. 7A, one side 36 and two corners 141A, 141B may be unitary, and separated by the remainder of the store display 30 including sides 32 and 34. The interior region 162 may be populated with shelves, bagging fixtures, additional charging cradles, display advertisement screens, and/or other components for capitalizing on the expanded size of the store display 30. In addition, at least one exterior side of the store display 30 may include a set of shelves 166, for example, shown in FIG. 7C.

Therefore, a feature is that the store display 30 may be in a closed state, for example, in FIGS. 6A-7, whereby the store display 30 may be positioned a small space in a store, for example, a corner region. In an open state, for example, shown in FIGS. 7A-7C, the store display 30 can be positioned at a larger area, for example, a central open space in a store. The store display 30 may include a set of wheels, for example, similar or the same as wheels 126 in FIG. 1 that are coupled to a bottom of the store display 30 for moving the entire store display 30 between locations, and/or for opening and closing the store display 30.

The embodiments and examples set forth herein are presented in order to best explain the present invention and its practical application and to thereby enable those of ordinary skill in the art to make and use the invention. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although example embodiments have been described with reference to the components, modules and units discussed herein, such functional elements may be combined into fewer elements or separated into additional elements. Various combinations of optional features have been described herein, and it will be appreciated that described features may be combined in any suitable combination.

What is claimed is:

1. A multi-purpose store display, comprising:
a central section including a set of mobile computer charging cradles, each constructed and arranged to receive, position, and electrically charge a mobile computing device;
a bag holder assembly at one or more sides of the central section that is constructed and arranged to hang a plurality of shopping bag; and
an electrical system for providing a source of power to the mobile computer charging cradles.

2. The multi-purpose store display of claim 1, wherein the bag holder assembly includes a bagging hook arrangement for hanging the shopping bags.

3. The multi-purpose store display of claim 2, wherein the bag holder assembly includes a wire frame that at least partially surrounds the bagging hook arrangement.

4. The multi-purpose store display of claim 1, wherein the central region includes a signage area.

5. The multi-purpose store display of claim 1, wherein the central section is modular, and includes a first portion and a second portion that abuts the first portion in a closed state and is separate from the first portion in an open state, wherein an interior region between the first portion and the second portion is expanded and exposed in the open state.

6. The multi-purpose store display of claim 1, further comprising an electronic kiosk coupled to the electrical system.

7. A multi-purpose store display, comprising:
a base including a first side, a second side, and a third side collectively constructed and arranged as a triangular configuration,
wherein at least one of the first through third sides includes a set of mobile computer charging cradles constructed and arranged to receive, position, and electrically charge the array of mobile computing devices,
wherein at least one other of the first through third sides includes at least one of a bag holder assembly or a set of shelves, and
wherein the base further includes an electronic kiosk that is collocated with the mobile computer charging cradles and the at least one of the bag holder assembly or set of shelves.

8. The multi-purpose store display of claim 7, further comprising an electrical system for providing a source of power to the mobile computer charging cradles.

9. The multi-purpose store display of claim 7, further comprising an electronic kiosk coupled to the electrical system and that communicates with the mobile computing devices in the mobile computer charging cradles.

10. The multi-purpose store display of claim 9, wherein the first side and the second side each comprises an array of the mobile computer charging cradles, and the third side includes the electronic kiosk.

11. The multi-purpose store display of claim 7, wherein the base further comprises one or more display panels.

12. The multi-purpose store display of claim 7, wherein the base is modular, and wherein at least one of the first through third sides abuts another of the first through third sides in a closed state and is separate from the other of the first through third sides in an open state, wherein an interior region formed by the first through third sides is expanded and exposed in the open state.

13. The multi-purpose store display of claim 7, further comprising corner regions between the first through third sides for additional elements of the bag holder assembly or additional mobile computer charging cradles.

14. A modular store display, comprising:
a first portion;
a second portion that abuts the first portion in a closed state and is separate from the first portion in an open state;
a first set of mobile computer charging cradles at the first portion;
a first set of shelves at the second portion; and
at least one of a second set of mobile computer charging cradles, a second set of shelves, or a bag holder assembly at an interior region between the first portion and the second portion in the open state.

15. The modular store display of claim 14, wherein the first portion includes first and second sides and the second portion includes a third side that separates from the first portion in the open state and that abuts the first portion in the closed state.

16. The modular store display of claim 15, wherein the third side includes a set of shelves.

17. The modular store display of claim 14, wherein in the open state, the interior region is expanded and exposed to accommodate additional mobile computer charging cradles.

18. The modular store display of claim 14, wherein the first portion further includes a bag holder assembly.
